(19) United States
(12) Patent Application Publication
(10) Pub. No.: US 2019/0311823 A1
(43) Pub. Date: Oct. 10, 2019

(54) PTC THERMISTOR MODULE

(71) Applicant: Mahle International GmbH, Stuttgart (DE)

(72) Inventors: Konrad Dubil, Karlsruhe (DE); Michael Kohl, Bietigheim-Bissingen (DE); Falk Viehrig, Stuttgart (DE)

(21) Appl. No.: 16/377,919

(22) Filed: Apr. 8, 2019

(30) Foreign Application Priority Data
Apr. 9, 2018 (DE) 102018205279.4

(51) Int. Cl. H01C 7/02; H05B 1/02

(52) U.S. Cl. CPC H01C 7/02; H01C 1/1406; H05B 1/0297

(57) ABSTRACT

A PTC thermistor module may include at least two PTC thermistor elements. The at least two PTC thermistor elements may be spaced apart from one another by separation sections. The at least two PTC thermistor elements may include two electric lines, spaced apart from one another, for the electrical supply of the PTC thermistor elements. An increased efficiency and operational reliability of the PTC thermistor module are achieved with an electrically insulating receiving body, in which the PTC thermistor elements are received, and which encompasses the PTC thermistor elements in a circumferential direction. A method for producing such a PTC thermistor module and a temperature control device may utilize at least one such PTC thermistor module.

### CROSS-REFERENCE TO RELATED APPLICATION

This application claims priority to German Application 10 2018 205 279.4 filed on Apr. 9, 2018, the contents of which are hereby incorporated by reference in its entirety.

### TECHNICAL FIELD

The present invention relates to a PTC thermistor module for a temperature control device, which has at least two PTC thermistor elements. The invention relates, furthermore, to a method for producing such a PTC thermistor module and a temperature control device with at least one such PTC thermistor module.

### BACKGROUND

Temperature control devices are used for controlling the temperature of a fluid or an object. For generating heat and therefore for heating in the temperature control device, it is known to use PTC thermistor elements, which have an increasing electrical resistance with increasing temperature. Such PTC thermistor elements, also designated as PTC elements, are advantageous in particular owing to their self-regulating characteristic. Such PTC thermistor elements are usually combined in PTC thermistor modules, wherein in the respective module usually a row of PTC thermistor elements is provided, to which an electrical voltage is applied during operation, in order to generate heat within the respective PTC thermistor element. The heat generated in the respective PTC thermistor element is usually discharged via sides of the respective PTC thermistor module facing away from one another and is used for the purpose of heating in the temperature control device. For this, generally heat-conducting plates are used, which are in heat-exchanging contact with the sides of the PTC thermistor elements which are facing away from one another, i.e. for example with an upper side and with an underside, facing away therefrom, of the respective PTC thermistor element, and which therefore discharge the generated heat and make it available for the temperature control device.

In particular owing to the electrical operation, in such PTC thermistor modules a range of safety factors are to be taken into consideration. This includes the electrical protection with respect to the exterior, which requires an electrical insulation of the PTC thermistor module. The protection from liquids, in particular the penetration of liquids into the interior of the PTC thermistor module, is to be prevented. These requirements are usually solved in that the PTC thermistor module is provided with further components which respectively at least partly fulfil a corresponding requirement, wherein these components are applied or respectively fastened to one another, in particular glued or pressed. For example, electric leads and the PTC thermistor elements are generally glued. In addition, the heat-conducting plates are applied to the electric leads, in particular glued. Also in an associated temperature control device, the respective PTC thermistor module is usually glued with further components of the temperature control device, which include for example frame parts, rib structures and suchlike.

This leads to a reduced transport of the heat generated by the PTC thermistor elements to the required locations in the temperature control device, which negatively impairs the efficiency of the PTC thermistor module. In addition, the applying of various components to one another harbours the danger that these do not form a uniform or flat abutment, so that the transport of heat between these components is also reduced. In particular, air pockets and uneven areas can form between these components, wherein the air pockets, in addition to a poor thermal conductivity, offer scope for electrical short-circuits and for the penetration of liquids.

These disadvantages are increased with increasing operating voltages of the PTC thermistor modules, because more and/or larger components come into use to fulfil the safety requirements. This applies, for example, to PTC thermistor modules which are used in electrically or at least partially electrically operated motor vehicles, in which the respective PTC thermistor module is operated with increasingly high electric voltages, in particular with the on-board electrical system voltage of the motor vehicle, which can be a few 100 V, for example 800 V.

The present invention is therefore concerned with the problem of indicating, for a PTC thermistor module with at least two PTC thermistor elements and for a method for producing the PTC thermistor module and for a temperature control device with such a PTC thermistor module, improved or at least alternative embodiments which are distinguished in particular by an increased safety and/or an improved efficiency.

This problem is solved according to the invention by the objects of the independent claims. Advantageous embodiments are the subject of the dependent claims.

### SUMMARY

The present invention is based on the general idea of receiving PTC thermistor elements of a PTC thermistor module in a receiving body which is electrically insulating but, at the same time, has good thermal conductivity, which encompasses the PTC thermistor elements in a circumferential direction. The receiving of the PTC thermistor elements in the receiving body leads in particular to a prevention or at least reduction of air pockets within the PTC thermistor module, so that the heat transmission within the PTC thermistor module and therefore from the PTC thermistor elements at outer surfaces of the PTC thermistor module is improved, and consequently the efficiency of the PTC thermistor module is increased. In addition, hereby in addition to an improved electrical insulation, also a prevention or at least reduction of the penetration of liquids into the PTC thermistor module is achieved, so that with the improved efficiency also the operational reliability of the PTC thermistor module, and namely also with the receiving body, is improved. In accordance with the idea of the invention, the PTC thermistor module has at least two PTC thermistor elements, which are arranged spaced apart from one another by separation sections, in particular along a row. The PTC thermistor module has, in addition, at least two electric lines, spaced apart from each other, for the electrical supply of the PTC thermistor elements, which are in electrical contact with the PTC thermistor elements. The PTC thermistor elements are received in the electrically insulating receiving body, which surrounds or respectively encompasses the PTC thermistor elements in a closed manner in a circumferential direction. The receiving body is therefore a body enveloping the PTC thermistor elements in a closed manner in circumferential direction, which body accordingly can also be designated as an electrically insulating enveloping body.

The electrically insulating characteristic of the receiving body is expediently configured such that it has a specific electrical resistance of at least 10⁸ Ω·cm. Therefore, an electrical insulation of the PTC thermistor elements is guaranteed or at least improved through the receiving body, also at high operating voltages of the PTC thermistor module, for example at voltages of at least 60 V, in particular at up to 800 V and more.

The receiving body is preferably embodied so as to be solid, i.e. not as a hollow body. This leads to an improved electrical insulation and to an improved heat transmission by means of the receiving body. In addition, air pockets in the PTC thermistor module, in particular between the receiving body and the PTC thermistor element, are therefore at least reduced.

Embodiments are preferred in which the receiving body lies, preferably flat, against at least one circumferential side of the respective PTC thermistor element, particularly preferably against at least two circumferential sides of the respective PTC thermistor element, wherein circumferential sides of the respective PTC thermistor element are the outer surfaces of the PTC thermistor element following one another in circumferential direction. Hereby, at said circumferential sides, a preferably flat contact exists between the receiving body and the PTC thermistor elements, which improves the heat transmission between the PTC thermistor elements and the receiving body and at least reduces air pockets between the receiving body and the PTC thermistor elements. Consequently, both the efficiency is raised, and also the operational reliability is increased. Embodiments are conceivable here, in which the receiving body lies against two opposite circumferential sides of the respective PTC thermistor element. The resting of the receiving body on the respective circumferential side is preferably flat. Here, the receiving body can lie directly against at least one of the circumferential sides.

The electrical contact between the respective line and the PTC thermistor elements is preferably realized by an abutting of the respective line against the respective PTC thermistor element. The abutting is advantageously flat and/or air-free. Particularly preferably, the abutting is direct, i.e. the respective line lies directly against the respective PTC thermistor element. The abutting of the respective line against the PTC thermistor elements leads, on the one hand, to the electrical current flowing in an improved manner between the lines and the PTC thermistor elements. In addition, hereby an improved heat transmission is present between the PTC thermistor elements and the lines. Furthermore the, in particular direct, abutting of the respective line against the PTC thermistor elements leads to air pockets between the PTC thermistor elements and the lines being prevented or at least reduced.

Embodiments are preferred, in which the respective line lies with an associated line section against at least one circumferential side of the respective PTC thermistor element, wherein the lines and the line sections of the different lines are, furthermore, spaced apart from one another.

Embodiments prove to be advantageous, in which the receiving body surrounds, in particular encompasses, at least one of the electric lines in circumferential direction. This means that the receiving body surrounds not only the PTC thermistor elements, but also at least one of the electric lines in circumferential direction, preferably in a closed manner. Particularly preferably, the receiving body lies here against at least one of the sides of the respective line which do not lie against the PTC thermistor element, in particular against the side of the respective line facing away from the PTC thermistor elements, wherein a direct abutting is preferred. Hereby, on the one hand, an additional fixing of the respective electric line in the PTC thermistor module and/or on the PTC thermistor elements, can be dispensed with. Furthermore, by means of the receiving body, at the same time an electrical insulation of the electric lines takes place, wherein this preferably takes place without air pockets, i.e. the receiving body lies directly against the respective electric line. When both lines are surrounded, in particular encompassed, by the receiving body, an interaction between the two lines outside the PTC thermistor elements, i.e. in particular short-circuits and suchlike, is also prevented or at least reduced, so that the operational reliability is further improved and/or the PTC thermistor module can be operated with a higher voltage.

In advantageous embodiments, at least one of the separation sections between two adjacent PTC thermistor elements is filled at least partly, particularly preferably entirely, by the receiving body. The receiving body can therefore, in the manner of a matrix, have mounts for the respective PTC thermistor element, wherein the mounts are spaced apart from one another. It is particularly preferred here if the receiving body lies in the separation sections against at least one of the face sides, delimiting the separation section, of at least one PTC thermistor element, preferably of both PTC thermistor elements, wherein the face side is an outer surface of the PTC thermistor element. Advantageously, the abutting is flat. Particularly preferably, the receiving body lies directly against at least one of the face sides, preferably both face sides. Therefore, an electrical insulation is also created between the PTC thermistor elements which are spaced apart from one another, which, in addition, prevents or at least reduces air pockets, wherein this, again, takes place with the same receiving body. At the same time, also, a form-fitting fixing of the PTC thermistor elements is achieved.

Through the, in particular direct, abutting of the receiving body against the PTC thermistor element or respectively the respective line, a heat transmission within the PTC thermistor module is improved, so that the efficiency of the PTC thermistor module is increased.

The receiving body has expediently a sufficient thermal conductivity for the transmission of heat occurring in the PTC thermistor elements during operation. Preferably, the receiving body has a thermal conductivity of at least 5 W/mK, particularly preferably of at least 20 W/mK, for example between 20 W/mK and 300 W/mK.

The receiving body can be produced basically in any desired manner, in so far as it is electrically insulating and encompasses the PTC thermistor elements in circumferential direction.

Embodiments are particularly preferred, in which the PTC thermistor elements are embedded into the receiving body. In the mounted state of the PTC thermistor module, the PTC thermistor elements are therefore securely integrated in the receiving body, in particular are fixed therein in a form-fitting and/or force-fitting manner. This makes it possible, on the one hand, to further prevent or at least reduce air pockets and, on the other hand, to increase the heat transmission within the PTC thermistor module.

It is conceivable to produce the receiving body in one piece and made from a single material, or respectively monolithically. Therefore, it is possible to carry out a more precise adaptation of the receiving body to the PTC thermistor elements and/or to the lines. In addition, hereby the risk of air pockets is further reduced and the heat transmission is further improved.

Embodiments are conceivable, in which the receiving body is constructed in several parts, wherein the parts of the receiving body, in the mounted state of the PTC thermistor module, are fixed to each other. This enables a more flexible installation of the PTC thermistor module.

Embodiments are to be considered in which the receiving body has two half-shells which follow one another in circumferential direction and extend along the PTC thermistor elements. This enables a simplified installation of the PTC thermistor module. For example, the PTC thermistor elements can be arranged in one of the half-shells and can be closed by the other half-shell such that the half-shells encompass the PTC thermistor elements in circumferential direction. It is also conceivable to arrange at least one of the lines in one of the half-shells before closing.

Embodiments are advantageous, in which the receiving body forms the outer surface of the PTC thermistor module, with which parts which are separate from the PTC thermistor module, for example an associated temperature control device exchange heat or respectively with which a fluid flowing around the PTC thermistor module exchanges heat. It is expedient here if the receiving body fixes the PTC thermistor elements and the lines.

Embodiments are also conceivable, in which the PTC thermistor module has a tubular body which forms the outer surface of the PTC thermistor module. The tubular body is, for example made from a metal or from a metal alloy and lies preferably directly and flat against the receiving body. This means that the tubular body encompasses the receiving body in circumferential direction and lies against the receiving body. With the tubular body, a mechanical stability of the PTC thermistor module is improved. In addition, it is hereby possible to protect the receiving body.

Embodiments prove to be advantageous, in which the receiving body is produced by a sintering method. The receiving body is advantageously sintered from a ceramic powder, with ceramic grains also being included, in particular a ceramic. This enables a simple production of the receiving body or respectively of the PTC thermistor module. In addition, consequently, accurately fitting formations of the receiving body are possible.

The production of the receiving body by the sintering method can comprise the production of several parts of the receiving body, for example the half-shells, or the production of the single-piece and monolithic receiving body.

For the latter variant, it proves to be advantageous if the PTC thermistor elements are arranged into a tool and the tool is subsequently filled with the ceramic powder and this is sintered for the production of the receiving body.

After the arranging of the PTC thermistor elements therein, the tool is filled with the ceramic powder such that after the sintering of the ceramic powder for producing the receiving body, no or at least reduced air pockets are present.

It is conceivable here, before the sintering of the ceramic powder, preferably also before the filling of the tool with the ceramic powder, that at least one of the lines, preferably both lines, is/are arranged into the tool. Therefore, in addition to the compact construction of the PTC thermistor module, air pockets between the receiving body and the at least one line are also prevented or at least reduced.

It shall be understood that, in addition to the PTC thermistor module, also a temperature control device belongs with the PTC thermistor module to the scope of this invention. The PTC thermistor module is used here for heating an object or a fluid, for example air.

It is conceivable to provide several PTC thermistor modules, spaced apart from one another, in a flow chamber of the temperature control device, which PTC thermistor elements are flowed around by a fluid during operation and thus heat the fluid. In the flow chamber, between adjacent PTC thermistor modules respectively at least one rib structure can be arranged, which is able to be flowed through for the fluid and therefore improves a heat transmission between the PTC thermistor module and the fluid.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained further in the following description, wherein the same reference numbers refer to identical or similar or functionally identical components.

### BRIEF DESCRIPTION OF THE DRAWINGS

There are shown, respectively diagrammatically

FIG. 1 an isometric internal view of a temperature control device with at least one PTC thermistor module,

FIG. 2 a section through the PTC thermistor module of the temperature control device,

FIG. 3 a section through the PTC thermistor module in another example embodiment,

FIG. 4 an isometric, partially transparent view of the PTC thermistor module in a further example embodiment,

FIG. 5 an isometric exploded illustration of the PTC thermistor module in a further example embodiment,

FIG. 6 an isometric exploded illustration of the PTC thermistor module in another example embodiment.

### DETAILED DESCRIPTION

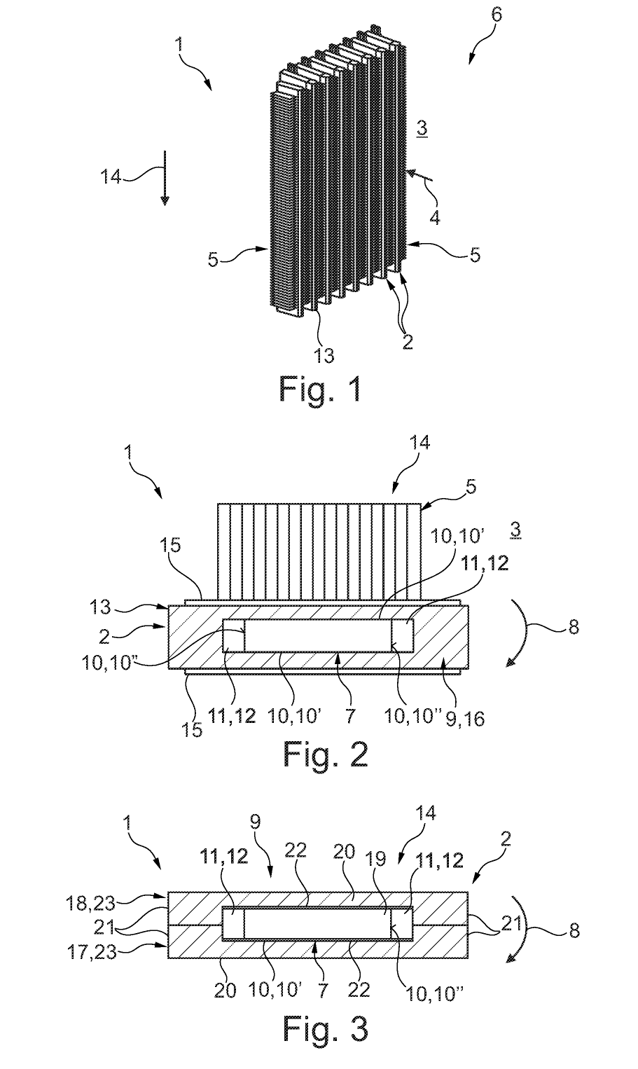

A temperature control device 1, as is illustrated in FIG. 1, has at least one PTC thermistor module 2, wherein the example which is shown has several PTC thermistor modules 2 which are arranged spaced apart from one another. The PTC thermistor modules 2 are arranged in a flow chamber 3 of the temperature control device 1, through which a fluid flows along a flow path 4 and thus flows around the PTC thermistor modules 2. Between the PTC thermistor modules 2 rib structures 5 are arranged, which lie on the face side against the PTC thermistor modules 2 and thus enlarge a heat-transmitting area within the temperature control device 1. The temperature control device 1 can be used for example in a motor vehicle 6, which is otherwise not shown. Heat is generated with the respective PTC thermistor module 2, which is emitted to the fluid and thus heats the latter.

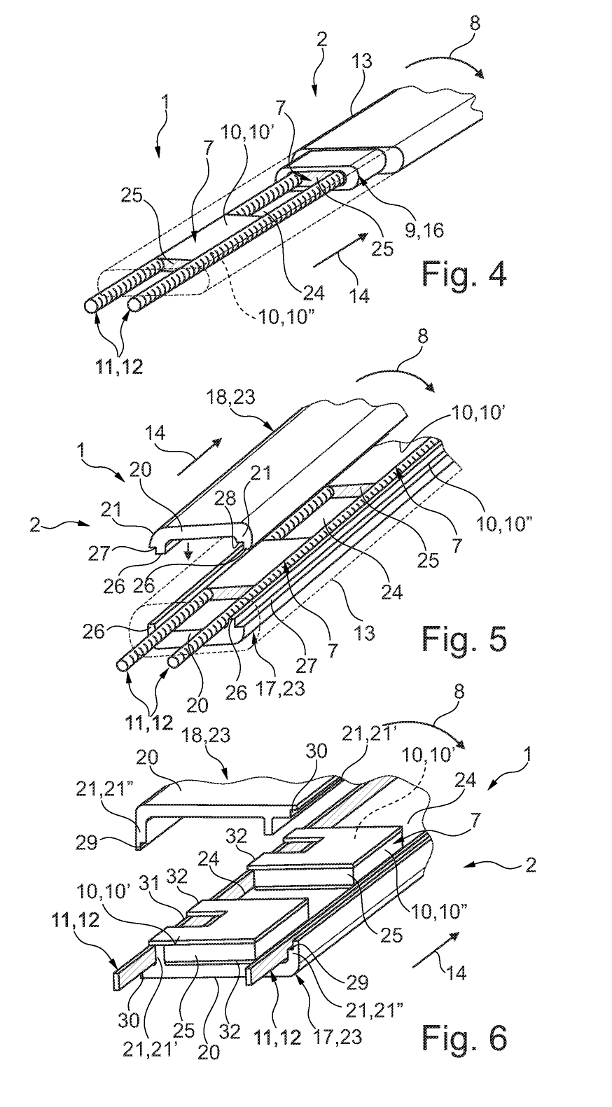

FIG. 2 shows a section through one of the PTC thermistor modules 2 in the temperature control device 1, wherein the rib structure 5 is illustrated on only one side of the PTC thermistor module 2. The PTC thermistor module 2 has several PTC thermistor elements 7, also designated as PTC elements, which are spaced apart from one another by separation sections 24 (see FIGS. 4 to 6), wherein the section shown in FIG. 2 leads through one of the PTC thermistor elements 7 such that a single one of the PTC thermistor elements 7 can be seen. The respective PTC thermistor element 7 has a positive temperature coefficient, i.e. an increasing electrical resistance with increasing temperature. In the example which is shown, the PTC thermistor element 7 is configured in a parallelepiped shape and has a rectangular cross-section. The PTC thermistor element 7 is surrounded in a closed manner, and therefore encompassed, by a receiving body 9 in a circumferential direction 8, which in the example which is shown runs around a longitudinal extent of the PTC thermistor module 2. The PTC thermistor element 7 has circumferential sides 10 following one another in circumferential direction 8, wherein through the elongate, parallele-piped-shaped formation of the PTC thermistor element 7 respectively two large circumferential sides 10′ and two small circumferential sides 10″ are arranged lying opposite. The respective circumferential side 10 forms here an outer surface of the PTC thermistor element 7. It can be seen that the receiving body 9 lies directly and flat against at least two of the circumferential sides 10, against the large circumferential sides 10′ in the example which is shown. An electric line 11, for example an electrode 12, respectively lies directly flat against the other circumferential sides 10. i.e. in the present case against the small circumferential sides 10″. The lines 11 are spaced apart from one another and serve for the electrical supply of the PTC thermistor elements 7. Accordingly, an electric current flows between the lines 11 via the PTC thermistor elements 7, which, owing to their positive temperature coefficient, generate heat in a regulated manner, which is used in the temperature control device 1 for heating the fluid. The electric lines 11 have a rectangular cross-section and are substantially aligned with the large circumferential sides 10′ of the PTC thermistor element 7. Here, the lines 11 are also surrounded in a closed manner and thus encompassed by the receiving body 9 in circumferential direction 8. Here, the receiving body 9, with the exception of the contact surfaces between the respective line 11 and the PTC thermistor element 7, lies in circumferential direction 8 directly and flat against the lines 11. It can be seen in particular from FIG. 2 that the PTC thermistor module 2 is therefore free of air pockets and uneven areas. The receiving body 9 is, in addition, electrically insulating, has in particular a specific electrical resistance of at least 10⁸ Ω·cm, so that it electrically insulates the electric lines 11 entirely in circumferential direction 8. The receiving body 9 has, in addition, a thermal conductivity of at least 5 W/mK, particularly preferably of at least 20 W/mK, in particular between 20 and 300 W/mK. Therefore it is possible, in addition, with the receiving body 9 to effectively discharge outwards the heat generated in the PTC thermistor element 7 and to provide it to the temperature control device 1, in particular to transmit it to the rib structures 5. This takes place here on the one hand via the large circumferential sides 10′ directly, and on the other hand via the small circumferential sides 10″ via the lines 11. In the example which is shown, the heat transmission to the fluid takes place via a tubular body 13, surrounding and therefore encompassing the receiving body 9 in a closed manner in circumferential direction 8, lying flat and directly against the receiving body 9. The tubular body 13 is, for example, made from a metal or a metal alloy and has, in addition to an advantageous thermal conductivity, a stabilizing characteristic which leads to a stabilizing of the receiving body 9 in which the PTC thermistor elements 7 are received, and in addition mechanically protects these. In the example shown in FIG. 2, the rib structures 5 are applied here onto the tubular body 13 for example via an adhesive layer 15.

In the example shown in FIG. 2, the receiving body 9 is produced in a single piece and monolithically, in particular as a ceramic body 16. The PTC thermistor elements 7 and the lines 11 are therefore embedded in the receiving body 9. For this, it is conceivable to arrange the PTC thermistor elements 7 and the lines 10 into a tool, which is not shown further, and to fill this with a ceramic powder (not shown) or ceramic grains, wherein the powder is subsequently sintered to produce the receiving body 9.

In FIG. 3 another example embodiment of the PTC thermistor module 2 is shown, in which the same view as in FIG. 2 can be seen, wherein the rib structure 5 and the adhesive layers 15 are not illustrated. Therefore, exclusively the PTC thermistor module 2 is shown. This example embodiment differs from the example shown in FIG. 2 in that the receiving body 9 is constructed having several parts, two parts in the example which is shown. The receiving body 9 therefore comprises two half-shells 17, 18. The half-shells 17, 18 follow one another in circumferential direction 8 and extend along the PTC thermistor elements 7 which are spaced apart from one another, in the example which is shown therefore along the longitudinal extent 14. In the example which is shown, the half-shells 17, 18 are constructed substantially identically and delimit jointly an interior 19 for the respective PTC thermistor element 7, in which the associated PTC thermistor element 7 and the two lines 11 are received. The half-shells 17, 18 have respectively a U-shaped cross-section with a base side 20 and legs 21 projecting therefrom, wherein the legs 21 lie against one another. It is conceivable to fix the respective PTC thermistor element 7 to at least one of the half-shells 17, 18. In the example which is shown, an adhesive layer 22 is provided for this between the respective base side 20 and the PTC thermistor element 7, in the present case the large circumferential side 10′ of the PTC thermistor element 7. The respective PTC thermistor element 7 can be arranged for mounting the PTC thermistor module 2 between the legs 21 of one of the half-shells 17, 18, for example of the first half-shell 17, and the first half-shell 17 can subsequently be closed by means of the second half-shell 18, in order to form the receiving body 9 which receives the PTC thermistor elements 7 and encompasses it is circumferential direction 8. Previously, between the respective leg 21 of the first half-shell 17 and the facing circumferential side 10 of the PTC thermistor element 7, in the present case the small circumferential side 10′, the line 11 is arranged, wherein the lines 11 and the PTC thermistor element 7 and the half-shells 17, 18 are dimensioned such that the PTC thermistor elements 7 and the lines 11 fill the respective interior 19 entirely, so that at least in the region of the PTC thermistor elements 7 no air pockets are present in the interior 19. With the two adhesive layers 22, the half-shells 17, 18 are also fastened to one another, wherein it is also conceivable to provide an adhesive layer, not shown, between the legs 21 which are lying on one another. In the example embodiment shown in FIG. 3 in addition no tubular body 13 is provided. In this example embodiment, the rib structures 5, which are not shown, are therefore applied directly against the receiving body 9. The half-shells 17, 18 can be respectively produced in any desired manner, in so far as they are electrically insulating. Preferably, the respective half-shell 17, 18 is made from ceramic, in particular a ceramic shell 23, which can be produced by the sintering of a ceramic powder.

Another example embodiment of the PTC thermistor module 2 can be seen in FIG. 4. The PTC thermistor module 2 shown in FIG. 4 corresponds substantially to the PTC thermistor module 2 shown in FIG. 2, wherein for better understanding the tubular body 13 is transparent and the receiving body 9 only partially shown. It is preferred here if the receiving body 9 also fills the separation sections 24 and lies directly and flat against the face sides 25 of the PTC thermistor elements 7 delimiting the associated separation section 24. The example embodiment shown in FIG. 4 differs from the one shown in FIG. 2 in addition in that the receiving body 9 does not have a parallelepiped-shaped, but rather an oval cross-section. The same applies for the tubular body 13. In addition, the PTC thermistor elements 7 in the example shown in FIG. 4 differ from the example shown in FIG. 2 in that the circumferential sides 10 against which the conductors 11 lie, in the present case therefore the small circumferential sides 10″, are not formed so as to be flat, but concave, in particular in a complementary manner to an outer contour of the line 11. In addition, the lines 11 or respectively electrodes 12 are configured so as to be rod-shaped with a round cross-section, such that they lie directly and flat against the associated circumferential side 10 of the respective PTC thermistor element 7, in the present case therefore the small circumferential side 10″.

FIG. 5 shows a further example embodiment of the PTC thermistor module 2. This corresponds in construction and form of the PTC thermistor elements 7 and of the lines 11 to the example embodiment of FIG. 4. The receiving body 9, however, is not constructed in one piece and integrally, but rather has two half-shells 17, 18 with a U-shaped cross-section. The respective half-shell has here a base side 20 and legs 21 projecting therefrom, wherein a shoulder 26 projects from the respective leg 21. Whereas one of the shoulders 26 is arranged on the outer edge of the associated leg 21, the other shoulder 26 is arranged on the inner edge of the associated leg 21. Hereby, an outer step 27 is formed between the shoulder 26 arranged on the inner side and the associated leg 21, whereas between the shoulder 26 arranged on the outer side and the associated leg 21 an inner step 28 is formed. The outer step 27 and the inner step 28 extend along the longitudinal extent 14, wherein in the mounted state of the PTC thermistor module 2 the shoulder 26 of the one half-shell 17, 18, lying on the interior, lies against the inner step 28 of the other half-shell 17, 18, whereas the shoulder 26 of the respective half-shell 17, 18 lying on the exterior lies against the outer step 27 of the other half-shell 17, 18. Therefore, the respective line 11 lies against the shoulder 26, lying on the inside, of one of the half-shells 17, 18. In this example, the receiving body 9 is not arranged in the separation sections 24 between the PTC thermistor elements 7. However, an example embodiment would also be conceivable in which the receiving body 9 fills at least one of the separation sections 24 and lies directly and flat against the face sides 25 delimiting the separation section 24. For this, one of the half-shells 17, 18, in particular the first half-shell 17, has projections which are not shown, wherein the respective projection fills one of the separation sections 24. Embodiments are also conceivable in which at least one of the separation sections 24 is at least partly filled by projections of both half-shells 17, 18. In the example shown in FIG. 5, in addition a tubular body 13 can be provided, as indicated in dashed lines.

A further example embodiment of the PTC thermistor module 2 is shown in FIG. 6. This example embodiment differs from the example embodiment shown in FIG. 2 by the construction of the half-shells 17, 18 and of the lines 11, in particular of the electrodes 12. The half-shells 17, 18 have respectively a U-shaped cross-section with a base side 20 and two legs 21 projecting therefrom, wherein one of the legs 21 is arranged offset inwards in cross-section and is also designated below as inner leg 21′, whereas the other leg 21 projects externally or respectively on the edge side of the base side 20 from the latter and is designated below as outer leg 21″. The inner leg 21′ and outer leg 21″ project at different distances from the base side 20, therefore have different heights. In the example which is shown, the inner leg 21′ is shorter than the outer leg 21″. On the outer leg 21″ on the face side an internally lying shoulder 29 is formed. At the end facing away from the long leg 21″ the base side 20 has an externally lying shoulder 30. In the mounted state of the PTC thermistor module 2, the externally lying shoulder 30 of the respective half-shell 17, 18 lies against the internally lying shoulder 29 of the other half-shell 17, 18. Therefore, the respective PTC thermistor element 7 is encompassed in circumferential direction 8 by the legs 21 and the base sides 20 of the half-shells 17, 18.

In FIG. 5 the respective line 11, 12 has a strip body 31 extending along the PTC thermistor elements 7, in the present case therefore along the longitudinal extent 14, wherein the strip body 31 of the respective line 11 has a parallelepiped-shaped cross-section and is arranged between the outer leg 21″ of one of the half-shells 17, 18 and the inner leg 21′ of the other half-shell 17, 18 and lies flat against these. The respective conductor 11 has, in addition, for the respective PTC thermistor element 7, a line section 32 which spans the adjoining inner leg 21′ and lies flat and directly against one of the circumferential sides 10 of the respective PTC thermistor element 7. In the example which is shown, the line sections 32 lie respectively against one of the large circumferential sides 10′ of the associated PTC thermistor element 7. In addition, in the example which is shown, provision is made that the line sections 32 of the respective line 11 lie against the same circumferential side 10 of the respective PTC thermistor element 7. In the example which is shown, therefore, a line section 32 of one of the lines 11 is arranged between the base side 20 of the respective half-shell 17, 18 and the facing circumferential side 10, in the present case therefore the facing large circumferential side 10′. In addition, one of the strip bodies 31 is arranged between the respective outer leg 21′ and the facing circumferential side 10, in the present case therefore the small circumferential side 10″, of the respective PTC thermistor element 7. In contrast, the respective half-shell 17, 18 lies with the inner leg 21′ directly and flat directly against the facing circumferential side 10, in the present case therefore the small circumferential side 10″, of the respective PTC thermistor element 7. In this example embodiment also a tubular body 13, which is not shown, can be provided, which encompasses the receiving body 9 in circumferential direction 8 and lies against it.

1. A PTC thermistor module for a temperature control device, for a motor vehicle, comprising:
at least two PTC thermistor elements which are spaced apart from one another by separation sections,
at least two electric lines spaced apart from one another for the electrical supply of the PTC thermistor elements, which are in electrical contact with the PTC thermistor elements, and
an electrically insulating receiving body, in which the PTC thermistor elements are received and which encompasses the PTC thermistor elements in a circumferential direction.

2. The PTC thermistor module according to claim 1, wherein the receiving body lies against at least two circumferential sides of the respective PTC thermistor element.

3. The PTC thermistor module according to claim 1, wherein the receiving body surrounds at least one of the electric lines in the circumferential direction, on sides of the line facing away from the PTC thermistor elements.

4. The PTC thermistor module according to claim 1, wherein the respective line lies with a projecting line section against at least one circumferential side of the respective PTC thermistor element, and the receiving body lies on the side facing away from the circumferential sides against the line sections.

5. The PTC thermistor module according to claim 1, wherein the receiving body fills at least one of the separation sections.

6. The PTC thermistor module according to claim 1, wherein the receiving body has a thermal conductivity of at least 5 W/mK.

7. The PTC thermistor module according to claim 1, wherein the receiving body is produced by a sintering method using a ceramic powder.

8. The PTC thermistor module according to claim 1, wherein the PTC thermistor elements are embedded in the receiving body.

9. The PTC thermistor module according to claim 1, wherein the receiving body is produced in a single piece and from a single material.

10. The PTC thermistor module according to claim 1, wherein the receiving body has two half-shells, which follow one another in the circumferential direction and extend along the PTC thermistor elements.

11. The PTC thermistor module according to claim 1, wherein the PTC thermistor module has a tubular body, which encompasses the receiving body in the circumferential direction.

12. A method for producing a PTC thermistor module (2) according to claim 1, wherein the receiving body is produced by the sintering of a ceramic powder.

13. The method according to claim 12, wherein the PTC thermistor elements are arranged into a tool, the tool is filled with the ceramic powder, and the ceramic powder is sintered for producing the receiving body.

14. A temperature control device for controlling the temperature of a fluid, comprising:
a flow chamber which is flowed through by the fluid during operation; and
at least one PTC thermistor module including:
at least two PTC thermistor elements that are spaced apart from one another by separation sections,
at least two electric lines spaced apart from one another for the electrical supply of the PTC thermistor elements, which are in electrical contact with the PTC thermistor elements, and an electrically insulating receiving body, in which the PTC thermistor elements are received and which encompasses the PTC thermistor elements in a circumferential direction,
wherein the at least one PTC thermistor module is in heat-exchanging contact with the fluid flowing through the flow chamber.

15. The temperature control device according to claim 14, further comprising a rib structure which is able to be flowed through is arranged in the flow chamber, wherein the rib structure is in heat-exchanging contact on a face side with at least one of the PTC thermistor modules.

16. The temperature control device according to claim 14, wherein the receiving body lies against at least two circumferential sides of the respective PTC thermistor element.

17. The temperature control device according to claim 14, wherein the receiving body surrounds at least one of the electric lines in the circumferential direction, on sides of the line facing away from the PTC thermistor elements.

18. The temperature control device according to claim 14, wherein the respective line lies with a projecting line section against at least one circumferential side of the respective PTC thermistor element, and the receiving body lies on the side facing away from the circumferential sides against the line sections.

19. The temperature control device according to claim 14, wherein the receiving body fills at least one of the separation sections.

20. The temperature control device according to claim 14, wherein the receiving body has a thermal conductivity of at least 5 W/mK
